(19) United States
(12) Patent Application Publication
(10) Pub. No.: US 2025/0253370 A1
(43) Pub. Date: Aug. 7, 2025

(54) COOLING SYSTEM FOR FUEL CELL ONBOARD A VEHICLE INCLUDING THERMAL ENERGY STORAGE DEVICE

(71) Applicant: ZeroAvia Ltd., Kemble (GB)

(72) Inventors: Matthew Graham Legg, Swindon (GB); Michael Patterson, Bath (GB); Seied Masoud Ameli, Swindon (GB); Christian Bailey, Palo Alto, CA (US)

(73) Assignee: ZeroAvia Ltd., Kemble (GB)

(21) Appl. No.: 18/856,861

(22) PCT Filed: Apr. 29, 2022
(86) PCT No.: PCT/GB2022/051113

§ 371 Date: Oct. 14, 2024

(51) Int. Cl. H01M 8/04746; B64D 27/31; B64D 27/355; B64D 33/10; H01M 8/04007

(52) U.S. Cl. CPC H01M 8/04768; B64D 27/31; B64D 27/355; B64D 33/10; H01M 8/04052; H01M 8/04059; H01M 2250/20

(57) ABSTRACT

A cooling system for a fuel cell onboard a vehicle includes a coolant circuit and a thermal energy storage device in fluid communication with the coolant circuit. The coolant circuit defines a coolant passageway and is configured to circulate a coolant through the coolant passageway and through a portion of the fuel cell to absorb heat from the fuel cell. The thermal energy storage device includes a phase change material configured to store thermal energy released from the coolant flowing through the coolant circuit and through the thermal energy storage device in the form of latent heat. The phase change material is configured to dissipate thermal energy stored therein to a circumambient airflow flowing relative to the vehicle when the vehicle is moving.

### FIELD

The present disclosure relates to cooling systems for fuel cells onboard vehicles and, more particularly, to cooling systems for fuel cells including thermal energy storage devices.

### BACKGROUND AND SUMMARY

This section provides background information related to the present disclosure which is not necessarily prior art. This section provides a general summary of the disclosure and is not a comprehensive disclosure of its full scope or all of its features.

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for fuel cell-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

In fuel cell-powered aircraft, the power output demanded of the fuel cells—and the amount of waste heat generated by the fuel cells—is oftentimes greatest during take-off and climb. Waste heat generated during operation of powered aircraft may be dissipated by positioning an air-cooled heat exchanger in an ambient airflow path through the aircraft. Directing ambient air to flow through the aircraft (instead of around the aircraft) when the aircraft is moving creates drag, with the amount of drag experienced by the aircraft being proportional to the volume of ambient air directed through the aircraft (and through the heat exchanger). In practice, the volume of the air-cooled heat exchanger (and the volume of air directed through the heat exchanger) may be selected to accommodate the most demanding cooling requirements of the aircraft, which may occur when the aircraft is operating under high load conditions, e.g., during take-off and climb. However, sizing the heat exchanger in this way may cause the aircraft to experience an unnecessarily large amount of drag when the aircraft is operating under low load conditions, e.g., during cruise, when minimal waste heat dissipation is needed. In addition, when cooling requirements are low, the presence of an oversized heat exchanger onboard the aircraft adds unnecessary weight and bulk to the aircraft.

It may be desirable to develop a system that can be used to effectively remove waste heat from a fuel cell onboard a vehicle during high load events without increasing the amount of drag experienced by the vehicle when the vehicle is operating under normal or low load conditions.

A cooling system for a fuel cell onboard a vehicle is disclosed. The cooling system comprises a coolant circuit and a thermal energy storage device. The coolant circuit defines a coolant passageway and is configured to circulate a coolant through the coolant passageway and through a portion of the fuel cell to absorb heat from the fuel cell. The thermal energy storage device is in fluid communication with the coolant circuit. The thermal energy storage device comprises a phase change material configured to store thermal energy released from the coolant flowing through the coolant circuit and through the thermal energy storage device in the form of latent heat. The phase change material is configured to dissipate thermal energy stored therein to an airflow flowing relative to the vehicle when the vehicle is moving

The vehicle may be an aircraft and the thermal energy storage device may be disposed within a wing of the aircraft.

The phase change material of the thermal energy storage device may be disposed adjacent an exterior panel defining a leading edge of the wing of the aircraft. In such case, the phase change material may be configured to dissipate stored thermal energy to the exterior panel defining the leading edge of the wing of the aircraft to remove ice accumulation therefrom.

The phase change material may be configured to store thermal energy in the form of latent heat when the vehicle is operating under high load conditions and to dissipate thermal energy stored therein when the vehicle is operating under low load conditions.

The phase change material of the thermal energy storage device may be disposed adjacent an exterior panel of the vehicle. In such case, the phase change material may be configured to dissipate thermal energy stored therein to a circumambient airflow flowing over an exterior surface of the exterior panel of the vehicle when the vehicle is moving.

During a high load event, an additional amount of thermal energy may be generated by the fuel cell, as compared to when the vehicle is operating under normal conditions or relatively low load conditions for the same duration. In such case, the mass of the phase change material may be selected such that a thermal energy storage capacity of the thermal energy storage device is greater than or equal to the additional amount of thermal energy generated by the fuel cell during the high load event.

The phase change material may be configured to dissipate thermal energy stored therein to the coolant flowing through the coolant circuit.

The phase change material may be a solid-to-liquid phase change material having a melting point greater than that of the coolant. The melting point of the solid-to-liquid phase change material may be less than a boiling point of the coolant.

The coolant circuit may comprise a bypass configured direct coolant circulating through the coolant passageway to selectively bypass the thermal energy storage device.

The cooling system may further comprise a controller configured to control operation of the bypass such that (i) the coolant passes through the thermal energy storage device when the vehicle is operating under high load conditions, and (ii) the coolant bypasses the thermal energy storage device when the vehicle is operating under low load conditions.

The cooling system may further comprise a sensor configured to sense a parameter of the phase change material indicative of a remaining thermal energy storage capacity of the phase change material. In such case, the controller may be configured to control operation of the bypass such that (i) the coolant passes through the thermal energy storage device when the remaining thermal energy storage capacity of the phase change material is greater than a defined amount, and (ii) the coolant bypasses the thermal energy storage device when the remaining thermal energy storage capacity of the phase change material is less than the defined amount.

The cooling system may further comprise a plenum including an inlet and an outlet in fluid communication with a circumambient environment of the vehicle. The inlet of the plenum may be configured to receive an airflow from the circumambient environment when the vehicle is moving. The plenum may be configured to direct the airflow from the circumambient environment through the vehicle. The phase change material may be configured to dissipate thermal energy stored therein to the airflow flowing through the plenum.

The cooling system may further comprise a heat exchanger. The heat exchanger may be in fluid communication with the inlet and the outlet of the plenum and may be configured to transfer heat from the coolant circulating through the coolant circuit to the airflow flowing through the plenum.

In some embodiments, the heat exchanger and the thermal energy storage device may be arranged in series in the coolant passageway of the coolant circuit.

In some embodiments, the heat exchanger and the thermal energy storage device may be arranged in parallel in the coolant passageway of the coolant circuit.

The cooling system may further comprise a third heat exchanger coupled to the fuel cell. The third heat exchanger may be configured to transfer heat from the fuel cell to the coolant circulating through the coolant circuit.

The fuel cell may comprise an anode configured to receive a hydrogen-containing reactant gas and to discharge a hydrogen-containing exhaust gas stream and a cathode configured to receive an oxygen-containing reactant gas and to discharge a water vapor-containing exhaust gas stream.

A vehicle is disclosed. The vehicle comprises an interior, a fuel cell disposed within the interior of the vehicle, and a cooling system disposed within the interior of the vehicle. The cooling system comprises a coolant circuit defining a coolant passageway and a thermal energy storage device in fluid communication with the coolant circuit. The coolant circuit is configured to circulate a coolant through the coolant passageway and through a portion of the fuel cell to absorb heat from the fuel cell. The thermal energy storage device includes a phase change material configured to store thermal energy released from the coolant flowing through the coolant circuit and through the thermal energy storage device in the form of latent heat. The phase change material is configured to dissipate thermal energy stored therein to an airflow flowing relative to the vehicle when the vehicle is moving

The phase change material may be configured to store thermal energy when the vehicle is operating under high load conditions and to dissipate thermal energy stored therein when the vehicle is operating under low load conditions.

During a high load event, an additional amount of thermal energy may be generated by the fuel cell, as compared to when the vehicle is operating under normal conditions or relatively low load conditions for the same duration. In such case, the mass of the phase change material may be selected such that a thermal energy storage capacity of the thermal energy storage device is greater than or equal to the additional amount of thermal energy generated by the fuel cell during the high load event.

The phase change material may be configured to dissipate thermal energy stored therein to the coolant flowing through the coolant circuit.

The vehicle may further comprise an exterior panel having an exterior surface and an opposite interior surface. The exterior surface of the exterior panel may be exposed to a circumambient environment of the vehicle and the interior surface of the exterior panel may at least partially define the interior of the vehicle. In such case, the phase change material of the thermal energy storage device may be disposed adjacent the interior surface of the exterior panel.

The phase change material may be configured to dissipate thermal energy stored therein to a circumambient airflow flowing over the exterior surface of the exterior panel when the vehicle is moving.

The vehicle may be an aircraft. The thermal energy storage device may be disposed within at least one of a wing, fuselage, or tail assembly of the aircraft. In such case, the thermal energy storage device may be configured to transfer thermal energy from the phase change material to the wing, fuselage, or tail assembly of the aircraft to remove ice accumulation therefrom.

The vehicle may further comprise a plenum including an inlet and an outlet in fluid communication with a circumambient environment of the vehicle. The inlet may be configured to receive an airflow from the circumambient environment when the vehicle is moving. The plenum may be configured to direct the airflow from the circumambient environment through the vehicle.

The vehicle may further comprise a heat exchanger in fluid communication with the inlet and the outlet of the plenum. The heat exchanger may be configured to transfer heat from the coolant circulating through the coolant circuit to the airflow flowing through the plenum when the vehicle is moving.

The phase change material may be configured to dissipate thermal energy stored therein to the airflow flowing through the plenum when the vehicle is moving.

The vehicle may further comprise a third heat exchanger coupled to the fuel cell. The third heat exchanger may be configured to transfer heat from the fuel cell to the coolant circulating through the coolant passageway of the coolant circuit.

The fuel cell may comprise an anode configured to receive a hydrogen-containing reactant gas and to discharge a hydrogen-containing exhaust gas stream and a cathode configured to receive an oxygen-containing reactant gas and to discharge a water vapor-containing exhaust gas stream.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a process flow diagram of a cooling system for a fuel cell onboard a vehicle, the cooling system comprising a coolant circuit, a plenum in fluid communication with a circumambient environment, a liquid-to-air heat exchanger, a thermal energy storage device, and a fuel cell heat exchanger coupled to the fuel cell.

FIG. 2 is a schematic depiction of an aircraft having an interior and a fuel cell disposed within the interior of the aircraft.

FIG. 3 is a schematic cross-sectional view of a wing of the aircraft of FIG. 2, wherein a thermal energy storage device is disposed within the wing of the aircraft.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

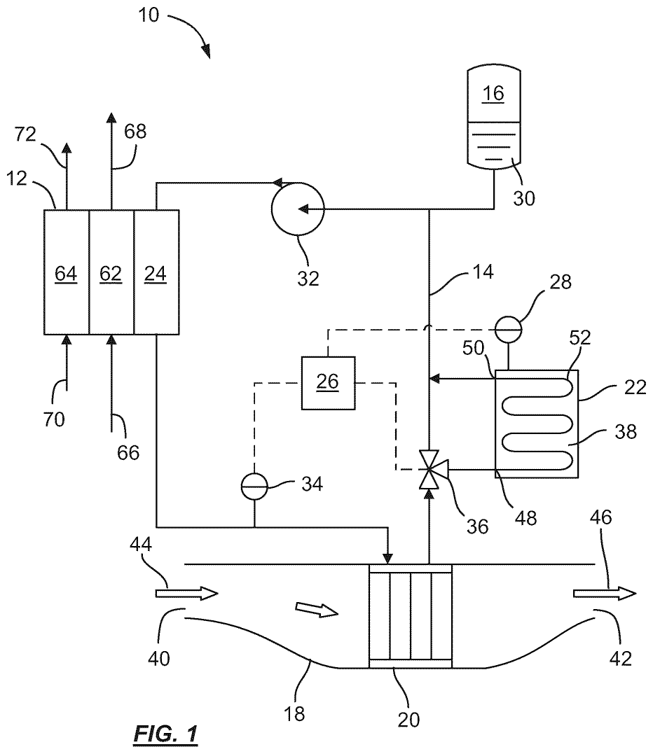

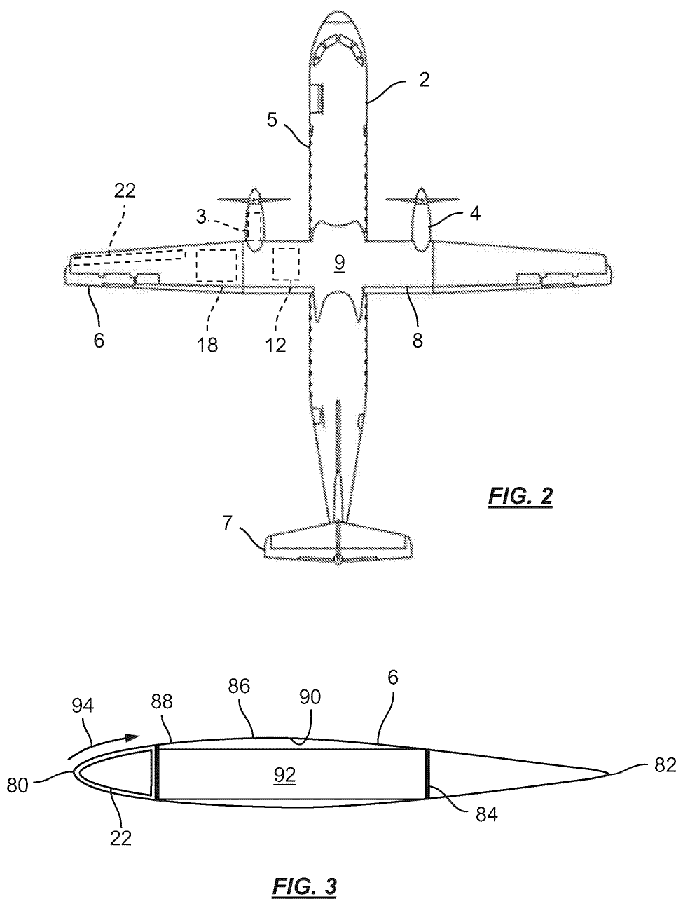

FIG. 1 depicts a process flow diagram of a cooling system 10 for a fuel cell 12 onboard a vehicle. As shown in FIG. 2, the fuel cell 12 may be located onboard an aircraft 2 that is powered at least in part by an electric motor 3 disposed within a streamlined enclosure or nacelle 4. The shape or structure of the aircraft 2 may be referred to as the airframe and may include the fuselage 5, wings 6, and tail assembly 7. The shape or structure of the aircraft 2 may be defined by one or more skin panels 8 having exterior surfaces exposed to a circumambient environment of the aircraft 2 and interior surfaces that at least partially define an interior 9 of the aircraft. In some embodiments, the fuel cell 12 may be disposed in one of the wings 6 of the aircraft 2. In some embodiments, the fuel cell 12 may be positioned in the fuselage 5 or in any other part of the aircraft 2.

The cooling system 10 may be configured to maintain the fuel cell 12 within an acceptable operating temperature range, for example, by transferring waste heat generated by the fuel cell 12 away from the fuel cell 12 to a cooling medium. The cooling system 10 may be configured to accommodate varying cooling requirements of the aircraft 2. To accomplish this, for example, the cooling system 10 may vary the amount of heat transferred away from the fuel cell 12, for example, to accommodate situations when the vehicle is operating under normal operating conditions, when the vehicle is operating under low load conditions (e.g., during cruise), or when the vehicle is operating under high load conditions (e.g., during take-off and climb). In some embodiments, when the fuel cell 12 is in the process of warming up to a desired operating temperature, the cooling system 10 may operate without transferring heat away from the fuel cell 12 until the desired operating temperature is reached.

The presently disclosed cooling system 10 will be described more fully hereinbelow with reference to the exemplary embodiment depicted in FIG. 1. The presently disclosed cooling system 10, however, is not limited to the arrangement shown in FIG. 1 and may be embodied in different forms. In addition, in the following description, the cooling system 10 is described with reference to use in an aircraft 2; however, the presently disclosed cooling system 10 is not limited to aircraft and may be used in a variety of different vehicle applications. The scope of the present disclosure is defined by the claims and their equivalents.

The cooling system 10 depicted in FIG. 1 includes a coolant circuit 14, a coolant header tank 16, a plenum 18, a liquid-to-air heat exchanger 20, a thermal energy storage device 22, a fuel cell heat exchanger 24 coupled to the fuel cell 12, a controller 26, and an energy storage capacity sensor 28 coupled to the thermal energy storage device 22. In the embodiment depicted in FIG. 1, the coolant circuit 14 defines a passageway for circulation of a coolant 30 through the cooling system 10 and optionally through the coolant header tank 16. The coolant circuit 14 includes a coolant pump 32, one or more temperature sensors 34, and a bypass valve 36.

The coolant 30 is formulated to assist in the transfer of thermal energy between various components of the cooling system 10 and in the discharge of waste heat from the cooling system 10 to an ambient environment. For example, the coolant 30 may comprise a heat transfer fluid having a high specific heat capacity and good thermal, chemical, electrical (e.g., not electrically conductive, dielectric), and mechanical compatibility with the other components of the cooling system 10. The coolant 30 may be an aqueous or nonaqueous fluid. In some embodiments, the coolant 30 may comprise or consist essentially of water. The coolant 30 may comprise one or more additives selected to impart certain desirable properties to the coolant 30, e.g., a relatively high boiling point and/or freezing point. Examples of additives include ethylene glycol and/or propylene glycol. In some embodiments, the coolant 30 may be formulated so that the coolant 30 exhibits a boiling point greater than the operating temperature and pressure of the passageway defined by the coolant circuit 14, the coolant header tank 16, the liquid-to-air heat exchanger 20, the thermal energy storage device 22, and the fuel cell heat exchanger 24. As such, the coolant 30 circulating through the coolant circuit 14 and through the coolant header tank 16, the liquid-to-air heat exchanger 20, the thermal energy storage device 22, and the fuel cell heat exchanger 24 may generally be in the form of a liquid.

The coolant pump 32 may be configured to circulate the coolant 30 through the coolant circuit 14. The one or more temperature sensors 34 may be configured to sense the temperature of the coolant 30 in the passageway defined by the coolant circuit 14. As shown in FIG. 1, one of the temperature sensors 34 may be positioned downstream of the fuel cell heat exchanger 24 and upstream of the bypass valve 36 in the passageway defined by the coolant circuit 14 and may be configured to sense the temperature of the coolant 30 exiting the fuel cell heat exchanger 24 and to transmit a signal to the controller 26 indicative of the temperature of the coolant 30 at that specific location within the passageway defined by the coolant circuit 14. In some embodiments, a temperature sensor (not shown) may be positioned upstream of the fuel cell heat exchanger 24 and downstream of the coolant header tank 16 and/or the coolant pump 32 in the passageway defined by the coolant circuit 14. In such case, the temperature sensor may be configured to sense the temperature of the coolant 30 prior to entering the fuel cell heat exchanger 24 and may be configured to transmit a signal to the controller 26 indicative of the temperature of the coolant 30 at that specific location within the passageway defined by the coolant circuit 14.

The bypass valve 36 may be positioned in the passageway defined by the coolant circuit 14, between the liquid-to-air heat exchanger 20 and the thermal energy storage device 22. In such an arrangement, the bypass valve 36 may be operable to control the flow of the coolant 30 exiting the liquid-to-air heat exchanger 20 so that the coolant 30 is either directed to flow through the thermal energy storage device 22 or is directed to bypass the thermal energy storage device 22. In some embodiments, for example, when the fuel cell 12 is in the process of warming up to a desired operating temperature, coolant 30 flowing through the coolant circuit 14 may be directed to bypass the fuel cell heat exchanger 24. In such case, the cooling system 10 may operate without transferring heat away from the fuel cell 12 until the fuel cell 12 reaches a desired operating temperature.

The coolant header tank 16 contains a volume of the coolant 30 and may help accommodate thermal expansion of the coolant 30 and ensure positive pressure is maintained within the coolant circuit 14 during operation of the cooling system 10.

The plenum 18 includes an inlet 40 and an outlet 42 in fluid communication with a circumambient environment of the aircraft 2. The inlet 40 of the plenum 18 is configured to receive an airflow 44 from the circumambient environment and the outlet 42 is configured to discharge a processed airflow 46 from the plenum 18, for example, to the circumambient environment. The airflow 44 introduced into the inlet 40 of the plenum 18 may be “ram air” and may be generated when the aircraft 2 is moving. The plenum 18 may be constructed and arranged to direct the airflow 44 through the aircraft 2 and through one or more components disposed within an airflow path through the plenum 18. As shown in FIG. 2, in some embodiments, the plenum 18 may be defined in the wing 6 of the aircraft 2. In some embodiments, the plenum 18 may be defined in the fuselage 5 of the aircraft 2 or in any other part of the aircraft 2, for example, in the nacelle 4 surrounding the electric motor 3.

The liquid-to-air heat exchanger 20 depicted in FIG. 1 is positioned in the airflow path defined between the inlet 40 and the outlet 42 of the plenum 18 and is configured to promote indirect heat transfer between the coolant 30 and the airflow 44 passing therethrough. The liquid-to-air heat exchanger 20 may include an airflow channel and a coolant channel separated by a thermally conductive barrier (not shown). The airflow channel of the liquid-to-air heat exchanger 20 may be in fluid communication with the inlet 40 and the outlet 42 of the plenum 18, and the coolant channel of the liquid-to-air heat exchanger 20 may be in fluid communication with the coolant 30 circulating through the coolant passageway defined by the coolant circuit 14. In some embodiments, the airflow channel of the liquid-to-air heat exchanger 20 may be in fluid communication with the inlet 40 and the outlet 42 of the plenum 18 but the liquid-to-air heat exchanger 20 may not be disposed directly within the plenum 18. In some embodiments, the thermally conductive barrier that physically separates the airflow channel from the coolant channel in the liquid-to-air heat exchanger 20 may be configured to prevent the passage or transfer of air and/or coolant 30 between the airflow channel from the coolant channel. In such case, sensible heat may be indirectly transferred between the coolant 30 flowing through the coolant channel and the airflow 44 flowing through the airflow channel of the liquid-to-air heat exchanger 20. For example, sensible heat may be transferred from the coolant 30 to the barrier disposed between the airflow channel and the coolant channel by convection, heat may be transferred through the barrier by conduction, and heat may be transferred from the barrier to the airflow 44 by convection. In some embodiments, the liquid-to-air heat exchanger 20 may be configured to evaporatively cool the coolant 30 flowing through the coolant channel. For example, in some embodiments, the thermally conductive barrier that physically separates the airflow channel from the coolant channel in the liquid-to-air heat exchanger 20 may be selectively permeable to one or more components of the coolant 30. In such case, latent heat transfer may occur from the coolant 30 flowing through the coolant channel to the airflow 44 flowing through the airflow channel by evaporation and transport of one or more components from the coolant 30, through the selectively permeable barrier, into the airflow 44.

Heat may be transferred from the coolant 30 to the airflow 44 within the liquid-to-air heat exchanger 20 to help remove waste heat generated by the fuel cell 12 from the cooling system 10. In some embodiments, the liquid-to-air heat exchanger 20 may be in the form of a double pipe, shell and tube, plate, plate and shell, adiabatic shell, finned tube, or plate and fin heat exchanger. The flow direction of the coolant 30 in the coolant channel may be parallel, opposite, or transverse to the flow direction of the airflow 44 in the airflow channel of the liquid-to-air heat exchanger 20.

The thermal energy storage device 22 is in fluid communication with the coolant 30 circulating through the coolant passageway defined by the coolant circuit 14 and includes a phase change material 38 configured to absorb thermal energy from the coolant 30 and to store the absorbed thermal energy in the form of latent heat. Thermal energy transferred from the coolant 30 to the phase change material 38 in the thermal energy storage device 22 effectively lowers the temperature of the coolant 30 circulating through the coolant passageway of the coolant circuit 14. In FIG. 1, the thermal energy storage device 22 is positioned downstream of the liquid-to-air heat exchanger 20 in the coolant passageway of the coolant circuit 14 and upstream of the coolant header tank 16 and the fuel cell heat exchanger 24, although other arrangements are possible. For example, in some embodiments, the thermal energy storage device 22 may be positioned downstream of the fuel cell heat exchanger 24 and upstream of the liquid-to-air heat exchanger 20 in the coolant passageway of the coolant circuit 14. In addition, in FIG. 1, the liquid-to-air heat exchanger 20 and the thermal energy storage device 22 are arranged in series in the coolant passageway of the coolant circuit 14. In some embodiments, the liquid-to-air heat exchanger 20 and the thermal energy storage device 22 may be arranged in parallel in the coolant passageway of the coolant circuit 14.

The thermal energy storage device 22 may include a coolant inlet 48 and a coolant outlet 50 in fluid communication with the coolant 30 circulating through the coolant passageway of the coolant circuit 14 and a coolant channel 52 defined between the coolant inlet 48 and the coolant outlet 50. The coolant channel 52 is in thermal communication with the phase change material 38 of the thermal energy storage device 22. In some embodiments, the coolant channel 52 may be defined by a thermally conductive barrier (not shown), and the thermally conductive barrier may be in direct or indirect contact with the phase change material 38 of the thermal energy storage device 22. In such case, in the thermal energy storage device 22, heat may be transferred from the coolant 30 flowing through the coolant channel 52, through the thermally conductive barrier, and to the phase change material 38. In the thermal energy storage device 22, heat may be transferred from the coolant 30 flowing through the coolant channel 52 to the phase change material 38 by convection, conduction, or a combination thereof. Heat may be transferred from the coolant 30 to the phase change material 38 to help remove excess waste heat generated by the fuel cell 12 from the cooling system 10, for example, which may be beneficial when the aircraft 2 is operating under high load conditions. During operation of the thermal energy storage device 22, a temperature difference between the coolant 30 flowing through the coolant channel 52 and the phase change material 38 may drive sensible heat transfer between the coolant 30 and the phase change material 38 via convection, conduction, or a combination thereof. When the coolant 30 exhibits a relatively high temperature, as compared to the temperature of the phase change material 38, sensible heat transfer between the coolant 30 and the phase change material 38 may increase the temperature of the phase change material 38 and reduce the temperature of the coolant 30. The amount and rate of sensible heat transfer between the coolant 30 flowing through the coolant channel 52 and the phase change material 38 depends, at least in part, on the specific heat capacity of the phase change material 38, the temperature difference between the coolant 30 and the phase change material 38, and the mass flow rate of the coolant 30.

As the temperature of the phase change material 38 in the thermal energy storage device 22 increases and approaches or reaches a phase change transition temperature of the phase change material 38 (i.e., the melting point or the boiling point of the phase change material 38) latent heat transfer may occur from the coolant 30 to the phase change material 38, with at least a portion of the phase change material 38 undergoing a change in phase. For example, in some embodiments, as the temperature of the phase change material 38 approaches or reaches a melting point of the phase change material 38, latent heat transfer from the coolant 30 to the phase change material 38 will cause at least a portion of the phase change material 38 to transition from a solid phase to a liquid phase. In some embodiments, as the temperature of the phase change material 38 approaches or reaches a boiling point of the phase change material 38, latent heat transfer from the coolant 30 to the phase change material 38 will cause at least a portion of the phase change material 38 to transition from a liquid phase to a gas phase. Latent heat transfer from the coolant 30 to the phase change material 38 may decrease the temperature of the coolant 30 without increasing the temperature of the phase change material 38. The amount of latent heat that can be transferred from the coolant 30 to the phase change material 38 depends on the amount of energy required to change the state of the phase change material 38 from a solid to a liquid and/or from a liquid to a gas and on the mass of the phase change material 38 in the thermal energy storage device 22. The amount of energy required to change the phase change material 38 from a solid to a liquid is known as the enthalpy of fusion or the latent heat of fusion and the amount of energy required to change the phase change material 38 from a liquid to a gas is known as the enthalpy of vaporization or the latent heat of fusion vaporization of the phase change material 38. The material properties and the mass of the phase change material 38 in the thermal energy storage device 22 may be selected to provide the thermal energy storage device 22 with sufficient thermal energy storage capacity to compensate for the additional amount of waste heat generated by the fuel cell 12 during high load events, e.g., during take-off and climb.

In situations where the aircraft 2 is operating under high load conditions, operation of the thermal energy storage device 22 may increase the cooling rate of the coolant 30, which may help compensate for circumstances in which the heat generation rate of the fuel cell 12 is relatively high, for example, which may occur when the aircraft 2 is operating under high load conditions. Operation of the thermal energy storage device 22 when the aircraft 2 is operating under high load conditions may help maintain the coolant 30 at a desirable operating temperature within the cooling system 10 by removing excess waste heat therefrom. The thermal energy storage device 22 can effectively remove excess waste heat from the cooling system 10 when the aircraft 2 is operating under high load conditions without increasing the volumetric flow rate of ambient air directed through the aircraft 2 (e.g., through the plenum 18), and thus without increasing the amount of drag experienced by the aircraft 2, which may increase the overall energy efficiency of the aircraft 2.

The mass of the phase change material 38 in the thermal energy storage device 22 may be selected to compensate for the increased waste heat generation rate of the fuel cell 12 when the aircraft 2 is operating under high load conditions by storing excess waste heat generated by the fuel cell 12 in the form of latent heat. The aircraft 2 may periodically operate under relatively high load conditions for certain established periods of time during certain types of events (e.g., during takeoff and climb). The waste heat generation rate of the fuel cell 12 may increase during such high load events by a known amount, as compared to the waste heat generation rate of the fuel cell 12 during relatively low load events (e.g., during cruise and/or descent). The overall amount of additional thermal energy generated by the fuel cell 12 during a single one of such high load events may be calculated based upon the duration of the event and the increase in the waste heat generation rate of the fuel cell 12. In some embodiments, the mass of the phase change material 38 in the thermal energy storage device 22 may be selected to achieve a thermal energy storage capacity that is greater than or equal to the amount of additional thermal energy generated by the fuel cell 12 during a single high load event.

The phase change material 38 may be a material having a high latent heat of fusion, latent heat of vaporization, and/or latent heat of transformation and the ability to undergo a phase change (or change in crystalline structure) when subjected to specific temperature and pressure conditions generated within the cooling system 10. For example, in some embodiments, the phase change material 38 may be a solid-to-liquid phase change material having a solid-to-liquid phase transition temperature (melting point) greater than the melting point of the coolant 30 and less than the boiling point of the coolant 30. In some embodiments, the phase change material 38 may be a liquid-to-gas phase change material having a liquid-to-gas phase transition temperature (boiling point) less than the boiling point of the coolant 30. In some embodiments, the phase change material 38 may be a solid-to-solid phase change material that stores and or releases thermal energy when the solid material transitions from one crystalline structure to another. In embodiments where the phase change material 38 is a solid-to-solid phase change material, the phase change material 38 may have a solid-to-solid crystalline phase transition temperature (transformation temperature) less than the boiling point of the coolant 30. In some embodiments, the phase change material 38 may be formulated to undergo a phase change (or change in crystalline structure) at atmospheric pressure at a temperature in a range of greater than or equal to about 45° C. to less than or equal to about 80° C. Examples of solid-to-liquid phase change materials include organic hydrocarbons (e.g., paraffins and long chain fatty acids), eutectic mixtures of organic hydrocarbons, and inorganic salt hydrates. Examples of liquid-to-gas phase change materials include water, polyethylene glycol, and combinations thereof. Examples of solid-to-solid phase change materials include polymer-based materials (including polyalcohol-based materials and polyurethane-based materials) and layered perovskites.

Latent heat stored in the phase change material 38 of the thermal energy storage device 22 may be gradually dissipated or discharged from the thermal energy storage device 22. In this way, the thermal energy stored within the phase change material 38 of the thermal energy storage device 22 when the aircraft 2 is operating under high load conditions may be gradually dissipated from the cooling system 10 over time. Reducing the temperature of the phase change material 38 in the thermal energy storage device 22 to below the phase transition temperature of the phase change material 38 may at least partially regenerate or recharge the phase change material 38 so that the phase change material 38 can store additional thermal energy in the form of latent heat. In some embodiments, latent heat stored in the phase change material 38 of the thermal energy storage device 22 may be gradually dissipated or discharged from the phase change material 38 by thermal energy transfer from the phase change material 38 to the coolant 30 flowing through the coolant channel 52 and through the coolant passageway defined by the coolant circuit 14. In some embodiments, latent heat stored in the phase change material 38 of the thermal energy storage device 22 may be gradually dissipated or discharged from the phase change material 38 to an airflow flowing relative to the aircraft 2 when the aircraft 2 is moving.

Referring now to FIGS. 2 and 3, the thermal energy storage device 22 is disposed within the interior 9 of the aircraft 2 and may be disposed within the airframe of the aircraft 2, e.g., within the fuselage 5, wings 6, or tail assembly 7. In some embodiments, the thermal energy storage device 22 may be disposed within the plenum 18 and may be in thermal communication with the airflow 44 flowing through the plenum 18. In such case, latent heat stored in the phase change material 38 of the thermal energy storage device 22 may be gradually dissipated or discharged from the phase change material 38 to airflow 44 flowing through the plenum 18 when the aircraft is moving. In some embodiments, the thermal energy storage device 22 may be disposed adjacent an interior surface of an exterior skin panel 8 of the aircraft 2. In the embodiment depicted in FIGS. 2 and 3, the thermal energy storage device 22 is disposed within one of the wings 6 of the aircraft 2.

As shown in FIG. 3, the wing 6 of the aircraft 2 may include a leading edge 80, a trailing edge 82, and a wing box 84 disposed therebetween. The shape of the wing 6 of the aircraft 2 may be defined by one or more exterior skin panels 86, with each skin panel 86 having an exterior surface 88 exposed to a circumambient environment of the aircraft 2 and an opposite interior surface 90 that at least partially defines an interior 92 of the wing 6. The thermal energy storage device 22 may be disposed within the interior 92 of the wing 6, within the leading edge 80, the trailing edge 82, and/or the wing box 84. In some embodiments, the thermal energy storage device 22 may be disposed adjacent the interior surface 90 of the skin panel 86 of the wing 6. In such an arrangement, thermal energy stored within the phase change material 38 of the thermal energy storage device 22 may be dissipated therefrom to a circumambient airflow 94 flowing over the exterior surface 88 of the skin panel 86 of the wing 6 of the aircraft 2 when the aircraft 2 is moving.

In some embodiments, the thermal energy storage device 22 may comprise a replacement for an existing bolt-on front section of the wing box 84. In such case, the thermal energy storage device 22 may itself define the leading edge 80 of the wing 6. A headspace of air may be provided at the top of the thermal energy storage device 22 to accommodate expansion (and contraction) of the phase change material 38, which may occur during phase changes and may result in a change in volume of the phase change material 38 by about 3% to about 10%. A path may be provided for air to escape and enter the thermal energy storage device 22 during expansion and contraction of the phase change material 38. This air path may be impermeable to the phase change material 38 and contaminants and may provide for venting in all orientations of the aircraft 2 (e.g., bank, climb, descent). This air path may be implemented for example in the same manner as fuel tank vents with which those skilled in the art are familiar

In some embodiments, the thermal energy storage device 22 may be configured to transfer thermal energy stored by the phase change material 38 to one or more components of the aircraft 2. Operation of the thermal energy storage device 22 for this purpose may be controlled or adjusted by the controller 26. For example, in situations where ice has accumulated on an exterior surface of the aircraft 2, e.g., on an exterior surface of the nacelle 4, fuselage 5, wings 6, and/or tail assembly 7 of the aircraft 2, the controller 26 may control operation of the thermal energy storage device 22 so that thermal energy stored in the phase change material 38 is transferred from the phase change material 38 to the nacelle 4, fuselage 5, wings 6, and/or tail assembly 7 of the aircraft 2 to melt the ice and remove the ice accumulation therefrom. A resulting benefit is that these one or more areas of the aircraft 2 will have inherent de-ice capability, thereby avoiding the installation of additional deicing systems, which may add significant weight and power cost to the aircraft 2.

In some embodiments, the phase change material 38 of the thermal energy storage device 22 may be located in an otherwise unused voluminous region of the aircraft 2, for example, in the wings 6. In aircraft powered by combustion engines, the liquid fuel (e.g., gasoline or kerosine) for engine operation is oftentimes stored in the wings of the aircraft. The aircraft 2 depicted in FIG. 2, however, is powered by the fuel cell 12 and thus does not need to store large volumes of liquid fuel in the wings 6. The thermal energy storage device 22 may be located within one or both of the wings 6 of the aircraft 2 to provide the cooling system 10 with the ability to rapidly transfer thermal energy away from the coolant 30 when the aircraft 2 is operating under relatively high load conditions. In addition, the thermal energy storage device 22 may be located within one or both of the wings 6 of the aircraft 2 to provide the cooling system 10 with the ability to store thermal energy released from the coolant 30 within the aircraft 2 itself in the form of latent heat. The thermal energy storage device 22 may provide the cooling system 10 with adequate cooling capabilities, without increasing the size of the liquid-to-air heat exchanger 20 and without increasing the aerodynamic drag experienced by the aircraft 2.

The energy storage capacity sensor 28 may be indirectly or directly coupled to the thermal energy storage device 22 and may be configured to sense one or more parameters indicative of the remaining thermal energy storage capacity of the phase change material 38 and to transmit a signal to the controller 26 indicative of the remaining thermal energy storage capacity of the phase change material 38. For example, in some embodiments, the energy storage capacity sensor 28 may be configured to sense the temperature, volume (e.g., amount of thermal expansion), electrical conductivity, optical behavior, and/or acoustic behavior of the phase change material 38.

In some embodiments, the controller 26 may control operation of the bypass valve 36 based upon information received from the one or more temperature sensors 34 and/or from the energy storage capacity sensor 28 of the thermal energy storage device 22. For example, if the temperature sensor 34 indicates that the temperature of the coolant 30 is below a defined temperature limit, the controller 26 may control operation of the bypass valve 36 so that the coolant 30 exiting the fuel cell heat exchanger 24 bypasses the thermal energy storage device 22 and does not flow through the thermal energy storage device 22. On the other hand, if the temperature sensor 34 indicates that the temperature of the coolant 30 is above a defined temperature limit, the controller 26 may control operation of the bypass valve 36 so that the coolant 30 exiting the fuel cell heat exchanger 24 is directed through the thermal energy storage device 22. In this way, excess waste heat generated by the fuel cell 12 when the aircraft 2 is operating under high load conditions may be stored in the phase change material 38 of the thermal energy storage device 22, for example, to help maintain the temperature of the coolant 30 (and of the fuel cell 12) within a desirable operating temperature range.

As another example, if the energy storage capacity sensor 28 indicates that the remaining thermal energy storage capacity of the phase change material 38 is below a defined limit, the controller 26 may control operation of the bypass valve 36 so that the coolant 30 exiting the fuel cell heat exchanger 24 bypasses the thermal energy storage device 22 and does not flow through the thermal energy storage device 22. On the other hand, if the energy storage capacity sensor 28 indicates that the remaining thermal energy storage capacity of the phase change material 38 is above a defined limit, the controller 26 may control operation of the bypass valve 36 so that the coolant 30 exiting the fuel cell heat exchanger 24 is directed through the thermal energy storage device 22. In this way, excess waste heat generated by the fuel cell 12 when the aircraft 2 is operating under high load conditions may be stored in the phase change material 38 of the thermal energy storage device 22, for example, to help maintain the temperature of the coolant 30 (and of the fuel cell 12) within a desirable operating temperature range.

The fuel cell 12 includes an anode 62 and a cathode 64 separated by an ionically conductive electrolyte (not shown). The anode 62 is configured to receive a hydrogen-containing reactant gas 66 and to discharge a hydrogen-containing exhaust gas stream 68. The cathode 64 is configured to receive an oxygen-containing reactant gas 70 and to discharge a water vapor-containing exhaust gas stream 72. During operation of the fuel cell 12, hydrogen in the hydrogen-containing reactant gas 66 is oxidized at the anode 62, producing positively charged ions (e.g., hydrogen ions) and electrons. The positively charged hydrogen ions travel through the ionically conductive electrolyte from the anode 62 to the cathode 64, while the electrons simultaneously travel from the anode 62 to the cathode 64 outside the fuel cell 12 via an external circuit (not shown), which produces an electric current. The electric current generated during operation of the fuel cell 12 may be used to power the electric motor 4 onboard the aircraft 2. On the cathode 64 side of the fuel cell 12, The oxygen-containing reactant gas 70 is reduced by the electrons arriving from the external circuit and combined with the positively charged hydrogen ions to form water vapor, which is discharged from the fuel cell 12 in the form of the water vapor-containing exhaust gas stream 72. The reaction between oxygen and hydrogen at the cathode 64 is exothermic, which generates heat.

The fuel cell heat exchanger 24 is thermally coupled to the fuel cell 12 and is configured to transfer heat from the fuel cell 12 to the coolant 30 circulating through the passageway defined by the coolant circuit 14 during operation of the cooling system 10 to help maintain the fuel cell 12 within a desired operating temperature range.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cooling system for a fuel cell onboard a vehicle, the cooling system comprising:
a coolant circuit defining a coolant passageway, the coolant circuit being configured to circulate a coolant through the coolant passageway and through a portion of the fuel cell to absorb heat from the fuel cell; and
a thermal energy storage device in fluid communication with the coolant passageway of the coolant circuit, the thermal energy storage device comprising a phase change material configured to store thermal energy released from the coolant flowing through the coolant passageway of the coolant circuit and through the thermal energy storage device in the form of latent heat,
wherein the phase change material is configured to dissipate thermal energy stored therein to an airflow flowing relative to the vehicle when the vehicle is moving.

2. The cooling system of claim 1, wherein the vehicle is an aircraft, and wherein the thermal energy storage device is disposed within a wing of the aircraft.

3. The cooling system of claim 2, wherein the phase change material of the thermal energy storage device is disposed adjacent an exterior panel defining a leading edge of the wing of the aircraft, and wherein the phase change material is configured to dissipate thermal energy stored therein to the exterior panel defining the leading edge of the wing of the aircraft to remove ice accumulation therefrom.

4. The cooling system of claim 1, wherein the phase change material is configured to store thermal energy in the form of latent heat when the vehicle is operating under high load conditions and to dissipate thermal energy stored therein when the vehicle is operating under low load conditions.

5. The cooling system of claim 1, wherein the phase change material of the thermal energy storage device is disposed adjacent an exterior panel of the vehicle, and wherein the phase change material is configured to dissipate thermal energy stored therein to a circumambient airflow flowing over an exterior surface of the exterior panel of the vehicle when the vehicle is moving.

6. The cooling system of claim 1, wherein, during a high load event, an additional amount of thermal energy is generated by the fuel cell, as compared to when the vehicle is operating under normal conditions or relatively low load conditions for the same duration, and wherein the mass of the phase change material is selected such that a thermal energy storage capacity of the thermal energy storage device is greater than or equal to the additional amount of thermal energy generated by the fuel cell during the high load event.

7. The cooling system of claim 1, wherein the phase change material is configured to dissipate thermal energy stored therein to the coolant flowing through the coolant circuit.

8. The cooling system of claim 1, wherein the phase change material is a solid-to-liquid phase change material having a melting point greater than that of the coolant, wherein the melting point of the solid-to-liquid phase change material is less than a boiling point of the coolant.

9. The cooling system of claim 1, wherein the coolant circuit comprises a bypass configured to direct coolant circulating through the coolant passageway to selectively bypass the thermal energy storage device.

10. The cooling system of claim 9, further comprising:
a controller configured to control operation of the bypass such that (i) the coolant circulating through the coolant passageway passes through the thermal energy storage device when the vehicle is operating under high load conditions, and (ii) the coolant circulating through the coolant passageway bypasses the thermal energy storage device when the vehicle is operating under low load conditions.

11. The cooling system of claim 10, further comprising:
a sensor configured to sense a parameter of the phase change material indicative of a remaining thermal energy storage capacity of the phase change material, wherein the controller is configured to control operation of the bypass such that (i) the coolant circulating through the coolant passageway passes through the thermal energy storage device when the remaining thermal energy storage capacity of the phase change material is greater than a defined amount, and (ii) the coolant circulating through the coolant passageway bypasses the thermal energy storage device when the remaining thermal energy storage capacity of the phase change material is less than the defined amount.

12. The cooling system of claim 1, further comprising:
a plenum including an inlet and an outlet in fluid communication with a circumambient environment of the vehicle, wherein the inlet is configured to receive an airflow from the circumambient environment when the vehicle is moving and the plenum is configured to direct the airflow from the circumambient environment through the vehicle, and wherein the phase change material is configured to dissipate thermal energy stored therein to the airflow flowing through the plenum.

13. A vehicle comprising:
an interior;
a fuel cell disposed within the interior of the vehicle; and
a cooling system disposed within the interior of the vehicle, the cooling system comprising:
a coolant circuit defining a coolant passageway, the coolant circuit being configured to circulate a coolant through the coolant passageway and through a portion of the fuel cell to absorb heat from the fuel cell; and
a thermal energy storage device in fluid communication with the coolant passageway of the coolant circuit, the thermal energy storage device comprising a phase change material configured to store thermal energy released from the coolant flowing through the coolant passageway of the coolant circuit and through the thermal energy storage device in the form of latent heat,
wherein the phase change material is configured to dissipate thermal energy stored therein to an airflow flowing relative to the vehicle when the vehicle is moving.

14. The vehicle of claim 13, wherein the phase change material is configured to store thermal energy when the vehicle is operating under high load conditions and to dissipate thermal energy stored therein when the vehicle is operating under low load conditions.

15. The vehicle of claim 13, wherein, during a high load event, an additional amount of thermal energy is generated by the fuel cell, as compared to when the vehicle is operating under normal conditions or relatively low load conditions for the same duration, and wherein the mass of the phase change material is selected such that a thermal energy storage capacity of the thermal energy storage device is greater than or equal to the additional amount of thermal energy generated by the fuel cell during the high load event.

16. The vehicle of claim 13, wherein the phase change material is configured to dissipate thermal energy stored therein to the coolant flowing through the coolant circuit.

17. The vehicle of claim 13, further comprising:
an exterior panel having an exterior surface and an opposite interior surface, the exterior surface of the exterior panel being exposed to a circumambient environment of the vehicle and the interior surface of the exterior panel at least partially defining the interior of the vehicle, wherein the phase change material of the thermal energy storage device is disposed adjacent the interior surface of the exterior panel, and wherein the phase change material is configured to dissipate thermal energy stored therein to a circumambient airflow flowing over the exterior surface of the exterior panel when the vehicle is moving.

18. The vehicle of claim 13, wherein the vehicle is an aircraft, the thermal energy storage device is disposed within at least one of a wing, fuselage, or tail assembly of the aircraft, and wherein the thermal energy storage device is configured to transfer thermal energy from the phase change material to the wing, fuselage, or tail assembly of the aircraft to remove ice accumulation therefrom.

19. The vehicle of claim 13, further comprising:
a plenum including an inlet and an outlet in fluid communication with a circumambient environment of the vehicle, wherein the inlet is configured to receive an airflow from the circumambient environment when the vehicle is moving and the plenum is configured to direct the airflow from the circumambient environment through the vehicle; and
a heat exchanger in fluid communication with the inlet and the outlet of the plenum, wherein the liquid-to-air heat exchanger is configured to transfer heat from the coolant circulating through the coolant passageway of the coolant circuit to the airflow flowing through the plenum when the vehicle is moving.

20. The vehicle of claim 19, wherein the phase change material is configured to dissipate thermal energy stored therein to the airflow flowing through the plenum when the vehicle is moving.
